(19) United States
(12) Patent Application Publication
(10) Pub. No.: US 2014/0032320 A1
(43) Pub. Date: Jan. 30, 2014

(54) Right Click Electronic Commerce Transactions

(71) Applicant: Sridhar Sivaraman, Tamilnadu (IN)

(72) Inventor: Sridhar Sivaraman, Tamilnadu (IN)

(73) Assignee: eBay, Inc., San Jose, CA (US)

(21) Appl. No.: 13/556,679

(22) Filed: Jul. 24, 2012

(51) Int. Cl. G06Q 30/02

(52) U.S. Cl. 705/14.54

(57) ABSTRACT

Embodiments of the present disclosure provide a right click transaction option and enhance the e-commerce experience In an embodiment, a system comprises a processor(s) and one or more memories in communication with the processor(s) and adapted to store a plurality of machine-readable instructions which when executed by the processor(s) are adapted to cause the system to: provide a right click transaction option as part of a right click context menu when a user of a client device right clicks on content associated with a selected item as presented on an entity's site; receive search information associated with the selected item from the user device when the user selects the right click transaction option; store the search information; and redirect the user to a service provider site of a server provider showing one or more items displayed from service provider supported business entities based on the received and stored search information.

### BACKGROUND

1. Technical Field

Embodiments of the present disclosure generally relate to methods and systems for electronic commerce, and more particularly, to methods and systems for providing right click options for electronic commerce transactions.

2. Related Art

With the expansion of electronic commerce over the Internet, consumers can easily and readily purchase applications, products and services throughout the world. Consumers may locate or identify a desired application, product or service on the Internet, such as with a personal computer (PC), laptop, tablet, personal digital assistant (PDA), mobile phone, or other suitable device. The consumer can then make the purchase by entering the amount of money to be transferred to the seller. For example, a consumer may search and select a characteristic such as the brand or color of an item before paying for the item.

Consumers may also bid on items online, where such bids do not represent a completed transaction, but simply a promise to pay that amount if the bid is the high bid.

Although current electronic commerce enables a consumer to search through a wealth of inventory in many different existing websites, and a consumer may also be able to see pictures of items that he or she is considering buying, there is something missing from online shopping experiences today that would make electronic commerce more convenient for consumers.

### BRIEF DESCRIPTION OF THE DRAWINGS

FIG. 1 illustrates a block diagram of a system adapted to conduct right click electronic commerce transactions in accordance with an embodiment of the present disclosure;

FIG. 2 illustrates a diagram of a method for right click electronic commerce transactions using a service provider in accordance with an embodiment of the present disclosure;

FIGS. 3-6 illustrate examples of screen shots for an e-commerce experience for a right click electronic commerce transaction on a client device in accordance with an embodiment of the present disclosure;

FIG. 7 is a method illustrating an e-commerce experience for right click electronic commerce transactions over a client device in accordance with an embodiment of the present disclosure;

FIGS. 8-9 illustrate information pages about a particular image in accordance with an embodiment of the present disclosure; and

FIG. 10 is a block diagram of a system suitable for implementing embodiments of the present disclosure.

It should be appreciated that like reference numerals are used to identify like elements illustrated in one or more of the figures.

### DETAILED DESCRIPTION

According to one or more embodiments of the present disclosure, a user may have an option to conduct a transaction, for example, buy an application, product and/or service (“item”), as part of a right click context menu. In that regard, a user may not only search through a wealth of online inventory and see photos of items that the user may consider buying, but the user may also, for example, right click on a visual representation (“image”) or text associated with the item, and as a result, obtain a list of top shopping websites with matching top best deals available for the item. Conveniently, the user may complete the transaction, for example, via an available payment option through a payment provider service such as PayPal®. As such, embodiments of the present disclosure enhance the electronic commerce experience.

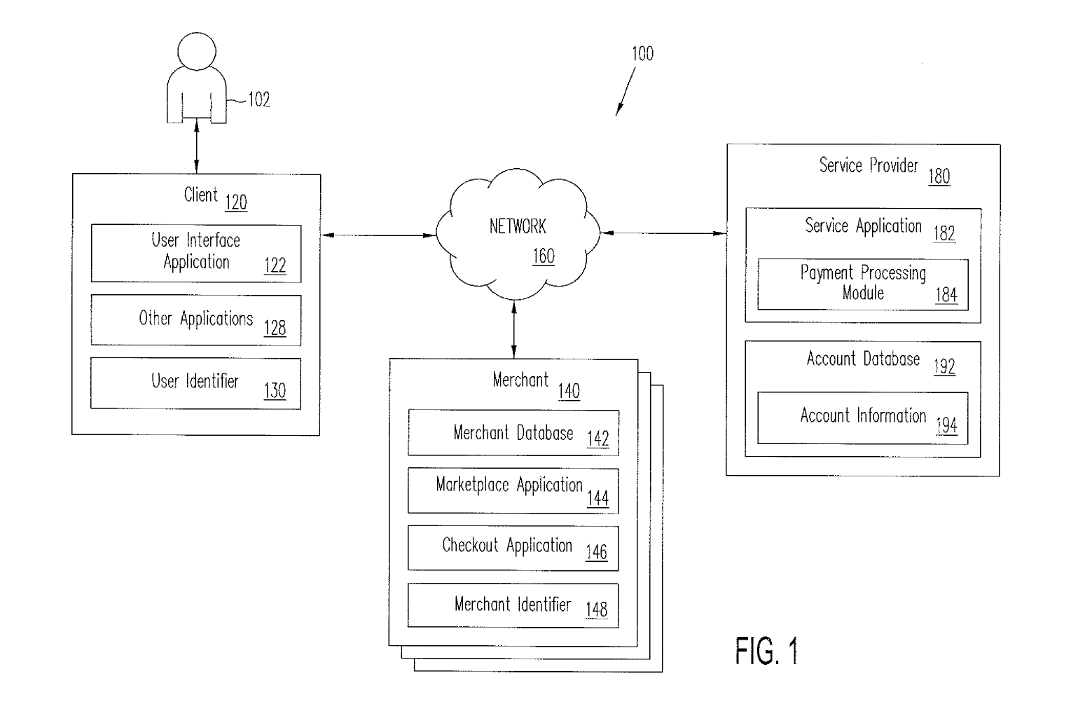

Referring to FIG. 1, a block diagram of a system 100 for right click electronic commerce transactions is illustrated in accordance with an embodiment of the present disclosure.

As shown in FIG. 1, system 100 includes at least one client device 120 (e.g., network computing device), one or more business entity or merchant servers or devices 140 (e.g., network server devices), and at least one service provider server or device 180 (e.g., network server device) in communication over a network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the client device 120, merchant servers or devices 140, and service provider server or device 180 may be associated with a particular link (e.g., a link, such as a URL (Uniform Resource Locator) to an IP (Internet Protocol) address).

The client device 120, in various embodiments, may be implemented using any appropriate combination of hardware and/or software configured for wired and/or wireless communication over the network 160. In various examples, the client device 120 may be implemented as a wireless telephone (e.g., cellular or mobile phone), a tablet, a personal digital assistant (PDA), a personal computer, a notebook computer, and/or various other generally known types of wired and/or wireless computing devices. Other examples of client device 120 include a television set, a game console, a Digital Video Recorder (DVR), and potentially other suitable devices. It should be appreciated that the client device 120 may also be referred to as a user device or a customer device without departing from the scope of the present disclosure.

The client device 120, in one embodiment, includes a user interface application 122, which may be utilized by the user 102 to conduct financial transactions (e.g., shopping, purchasing, bidding, etc.) with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160. In another example, the user 102 is able to access merchant websites via the one or more merchant servers 140 to view and select items for purchase, and the user 102 is able to purchase items from the one or more merchant servers 140 via the service provider server 180. Accordingly, the user 102 may conduct transactions (e.g., purchase and provide payment for items) from the one or more merchant servers 140 via the service provider server 180.

The client device 120, in various embodiments, may include other applications 128 as may be desired in one or more embodiments of the present disclosure to provide additional features available to the user 102. In one example, such other applications 128 may include security applications for implementing client-side security features, programmatic client applications for interfacing with appropriate application programming interfaces (APIs) over the network 160, and/or various other types of generally known programs and/or software applications. In still other examples, the other applications 128 may interface with the user interface application 122 for improved efficiency and convenience.

According to one or more embodiments, the user interface application 122 or the other applications 128 include a payment application that may be loaded on client device 120 by service provider server 180. Such payment application enables user 102 to easily make payments for items over client device 120.

The client device 120, in one embodiment, may include at least one user identifier 130, which may be implemented, for example, as operating system registry entries, cookies associated with the user interface application 122, identifiers associated with hardware of the client device 120, or various other appropriate identifiers. The user identifier 130 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 130 may be passed with a user login request to the service provider server 180 via the network 160, and the user identifier 130 may be used by the service provider server 180 to associate the user 102 with a particular user account maintained by the service provider server 180.

The one or more merchant servers 140, in various embodiments, may be maintained by one or more entities, for example profit or nonprofit business entities (or in some cases, by a partner of a business entity that processes transactions on behalf of business entities). Examples of business entities include merchant sites, resource information sites, review sites, utility sites, real estate management sites, social networking sites, etc., which may offer various items for purchase and payment. In some embodiments, business entities may need registration of the user identity information as part of offering the items to the user 102 over the network 160. As such, each of the one or more merchant servers 140 may include a merchant database 142 for identifying available items, which may be made available to the client device 120 for viewing and purchase by the user 102. It should be appreciated that although a user-merchant transaction is illustrated in this embodiment, the system may also be applicable to user-user, merchant-merchant and/or merchant-user transactions.

Each of the merchant servers 140, in one embodiment, may include a marketplace application 144, which may be configured to provide information over the network 160 to the user interface application 122 of the client device 120. For example, the user 102 may interact with the marketplace application 144 through the user interface application 122 over the network 160 to search and view various items available for purchase in the merchant database 142.

Each of the merchant servers 140, in one embodiment, may include a checkout application 146, which may be configured to facilitate online financial transactions (e.g., purchase transactions) by the user 102 of items identified by ₜhe marketplace application 144. As such, in one aspect, the checkout application 146 may be configured to accept payment information from the user 102 over the network 160.

Each of the merchant servers 140, in one embodiment, may include at least one merchant identifier 148, which may be included as part of the one or more items made available for purchase so that, e.g., particular items are associated with particular merchants. In one implementation, the merchant identifier 148 may include one or more attributes and/or parameters related to the merchant, such as business and banking information. In one or more embodiments, the user 102 may conduct financial transactions (e.g., selection, monitoring, purchasing, and/or providing payment for items) with each merchant server 140 via the service provider server 180 over the network 160.

The service provider server 180, in one embodiment, may be maintained by a transaction processing entity, which may provide processing for financial transactions and/or information transactions between the user 102 and one or more of the merchant servers 140. As such, the service provider server 180 includes a service application 182, which may be adapted to interact with each client device 120 and/or each merchant server 140 over the network 160 to facilitate the selection, purchase, and/or payment of items by the user 102 from one or more of the merchant servers 140. In one example, the service provider server 180 may be provided by PayPal®, Inc. and/or eBay®, Inc. of San Jose, Calif., USA.

The service application 182, in one embodiment, utilizes a payment processing module 184 to process purchases and/or payments for financial transactions between the user 102 and each of the merchant servers 140. In one implementation, the payment processing module 184 assists with resolving financial transactions through validation, delivery, and settlement. As such, the service application 182 in conjunction with the payment processing module 184 settles indebtedness between the user 102 and each of the merchants 140, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102) and merchants (e.g., one or more merchants associated with merchant servers 140). For example, account information 194 may include private financial information of each user 102 and each merchant associated with the one or more merchant servers 140, such as one or more account numbers, passwords, credit card information, banking information, or other types of financial information, which may be used to facilitate financial transactions between the user 102 and the one or more merchants associated with the merchant servers 140. In various aspects, the methods and systems described herein may be modified to accommodate users and/or merchants that may or may not be associated with at least one existing user account and/or merchant account, respectively.

In one implementation, the user 102 may have identity attributes stored with the service provider server 180, and the user 102 may have credentials to authenticate or verify identity with the service provider server 180. User attributes may include personal information, banking information and/or funding sources as previously described. In various aspects, the user attributes may be passed to the service provider server 180 as part of a login, selection, purchase, and/or payment request, and the user attributes may be utilized by the service provider server 180 to associate the user 102 with one or more particular user accounts maintained by the service provider server 180.

In operation, according to one or more embodiments of the present disclosure, when a user runs system 100 illustrated in the embodiment of FIG. 1, the system may display a screen shot of a website such as a search engine site on the user's client device 120 showing various images and/or text associated with one or more searched items. Upon right clicking on particular data or content, e.g., an image or text, associated with a selected item, the user may be provided with an option for a potential transaction associated with the selected item (e.g. buy) as part of a right click context menu. Data or search information including, for example, a name, text, a word(s), a search string or a parameter(s) associated with the item may be passed and stored at a server at a remote location, for example, service provider server 180. Based on the data or search information, the service provider server may use such data to search for the selected item in all or some server provider server websites. The user may then be presented with a site that includes a listing, directory, icons, etc. of online or network-based business entities (e.g., merchant sites) that offer the particular item as well as selections of other items along with top matching deals for users to view, select, monitor and/or purchase. The user may also be presented with an option to buy one or more particular items using service provider server 180.

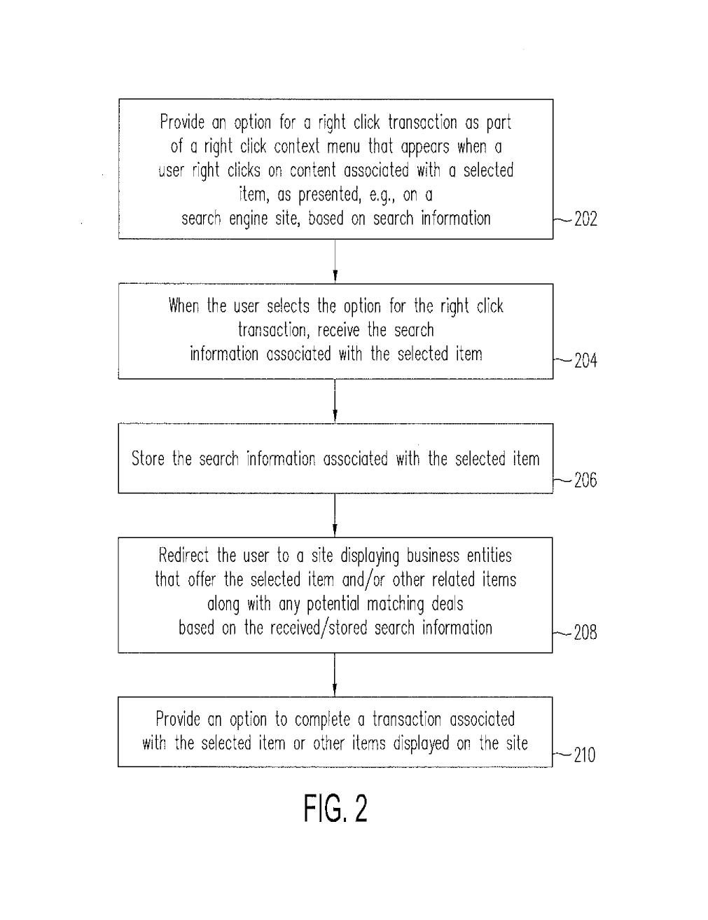

Referring now to FIG. 2, a method for right click electronic commerce transactions using a service provider is illustrated in accordance with an embodiment of the present disclosure. It should be noted that the method illustrated in FIG. 2 may be implemented by the system illustrated in FIG. 1 according to one or more embodiments.

In one embodiment, when using a search engine site such as Google® images, a user may conduct an online search, view and navigate multiple items such as digital cameras that may be available for viewing and purchasing from one or more business entities' sites. In other embodiments, the user may visit any website, for example, shopping sites or review sites to see reviews about one or more items, for example, the latest gadget in a market area. In one aspect, the user may search for, view and navigate specific characteristics of an item by entering specific search information such as a name, a word, text, a parameter, a search string, etc. including, e.g., one or several brands, model numbers, colors, sizes, number of pixels, etc. for items that may be offered by the online business entities.

Once a user searches, views and/or navigates items offered by online or network-based business entities, the user may right click on content associated with a selected item such as an image or text of a specific item of specific characteristics such as a particular brand, model, size, color and/or number of pixels. A right click menu may appear from which the user may select an option so that the user may conduct a right click transaction (e.g., buy) for the specific item. The user may then be redirected to a single site to see a listing, directory or icons of merchant websites that may offer the specific item, related items and/or the best potential matching deals. The user may then select to conduct a transaction associated with the specific item or other related items via a service provider server.

In block 202 of FIG. 2, a server at a remote location, for example, service provider server 180 of FIG. 1, may provide an option to a user for a right click transaction (e.g., buy) as part of a right click context menu when the user right clicks on content associated with a selected item, as presented, e.g., on a site such as a search engine site, a shopping site, a review site, etc. based on search information such as a search string entered by the user, the name (or text) of an image, and/or the like.

In block 204, the remote location server may receive the search information associated with the selected item when the user right clicks on the content associated with the selected item.

In block 206, the remote location may store the search information associated with the selected item.

In block 208, the user may be redirected to a single site displaying business entities (which may be supported by the server at the remote location) that offer the selected item and/or other related items along with any potential matching deals based on the received/stored search information.

In block 210, the user may be provided with an option to complete a transaction associated with the selected item or other items displayed on the single site. The user may complete the transaction through the server at the remote location, for example, service provider server 180.

In an embodiment where the user searches for an item on a search engine site (e.g. Google® images), the user may right click and select the right click transaction option (which may be labeled, for example, as “Paypal® Buy”) associated with a selected item in the results page of the search engine site. Once the user selects the right click transaction option, the user may get a list of top sites such as shopping sites with potential top best matching deals available from the sites. The user may also get an option to conduct one or more transactions in connection with items displayed on the list of top sites through the service provider server, for example, through a Paypal® payment option. According to one or more embodiments, search information including, for example, the text (or name) of an image may be chosen as a reference point to search for the selected item in all payment provider supported websites.

In another embodiment where the user visits any website (e.g. shopping sites, review sites to see reviews about an item such as the latest gadget, etc.), the user may see text associated with a desired item. The user may then right click on the text associated with any desired item and select the right click transaction option (which may be labeled, for example, as “Paypal® Buy”) associated with a selected item in the results page. Once the user selects the right click transaction option, the user may get a list of top sites such as shopping sites with potential top best matching deals. The user may also get an option to conduct one or more transactions in connection with items displayed on the list of top sites through the service provider server, for example, through a Paypal® payment option. According to one or more embodiments, search information including, for example, a string from an image name may be taken directly (closely matching with a web page title) and may be chosen as a reference point to search for the selected item in all payment provider supported websites.

In one example, when the user searches any images, for example on Google® images, from the resultant page, the user may select the “image name string” and then perform a right click transaction operation, for example, select a “PayPal Buy” right click operation.

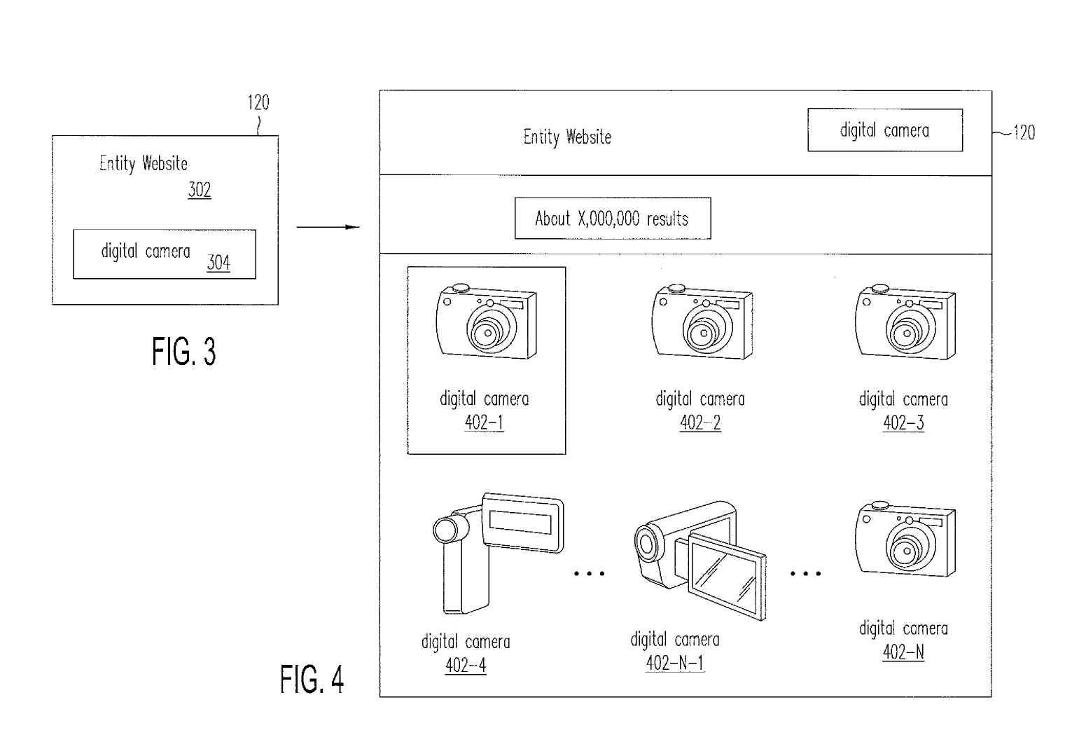

Referring now to FIGS. 3-6, screen shots for a right click transaction on a client device are illustrated in accordance with an embodiment of the present disclosure.

In FIG. 3, a screen shot of a client device 120 illustrates a portion of a page of an entity website according to an embodiment. In various embodiments, a display component 302 of client device 120 may be adapted to display, in an environment of the client device 120, an entity's website in a browser window. The page of the entity website may be a search page such as an image search page of a search engine site, a shopping site, a review site, a social network site, or any other business entity site.

In that regard, a user may routinely search for desired items on search engine sites such as Google®, Yahoo®, Bing®, and the like. Generally, a search engine site such as Google® may provide an option to search content by a name, text, a parameter, a word(s), a search string(s) and/or the like. In addition, a search engine site may provide an image search feature that allows users to search sites for image content. A user may enter keywords or a search string for the image search based on, for example, a filename of the image, a link text pointing to the image, and/or text adjacent to the image. A user may search for any desired item based on various item characteristics, for example, by brand, model, size, number of pixels, color, etc. In an embodiment, the user may conduct an image search on a search engine site images page by entering e.g., text, words or a search string associated with a desired item, for example, the user may search for a digital camera by entering “digital camera” (or any other appropriate search string or text) in input box 304 displayed on display component 302. It should be noted that the user may narrow a search by entering any additional desired characteristics, for example, the user may search for “Sony® digital camera,” “Canon® EOS Rebel”, etc.

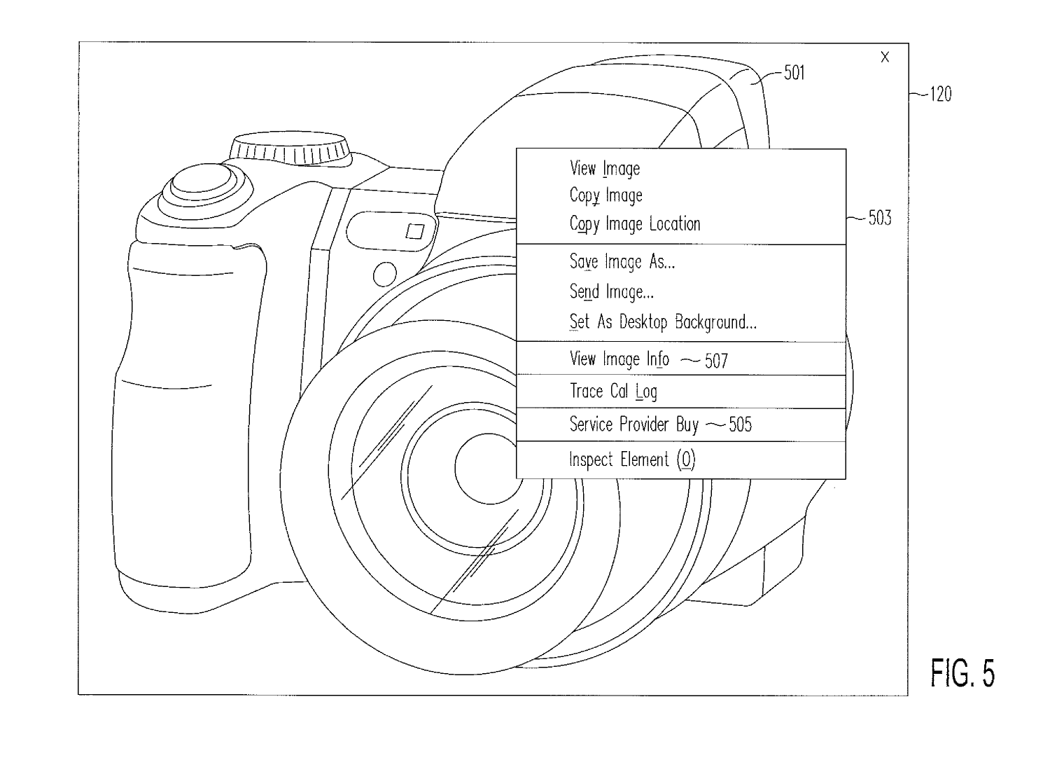

In FIG. 4, a screen shot of a client device 120 illustrates an image search results page of an entity website according to an embodiment. When a user searches for a desired item, for example on an image search engine site, a thumbnail of each matching image may be displayed on the entity's website. In this example, when the user searches for a “digital camera” on an image search engine site, the image search results page may show an N number of thumbnails of images 402-1 to 402N, where N is an integer number, which match the entered search string “digital camera.”

FIG. 5 illustrates a screen shot of a client device 120 illustrating an image of a selected item with a corresponding right click context menu according to an embodiment.

In general, when the user clicks on a selected thumbnail, for example on a thumbnail 402-1 as illustrated in FIG. 4 according to an embodiment, the selected image may be displayed in a box over a website from which the image originally was obtained. In this embodiment, the user may select a particular camera from the N items retrieved by the search by clicking on its corresponding thumbnail, for example, on thumbnail 402-1. As illustrated in FIG. 5 according to an embodiment, the user may “right-click” on the image of a selected item 501 (e.g., an image of a selected thumbnail 402-1 of a digital camera) and as a result, a right click context menu 503 may appear in connection with the selected item. Generally, right click context menu 503 may present the user with several options to, for example, “View Image”, “Copy Image”, “Copy Image Location, “Save Image As . . . ”, “Send Image . . . ”, “Set As Desktop Background . . . ”, “View Image Info”, and/or any other suitable right click options. Notably, as part of the menu options presented in right click context menu 503, the user may also be presented with an option to conduct a transaction associated with the selected item (also referred to as “right click transaction option”). For example, the right click context menu 503 may include an option that may be labeled “Service Provider Buy” 505, which may involve the option to conduct a transaction, for example, for viewing, shopping, monitoring, bidding or buying the selected item 501. It should be noted that the option to conduct a transaction associated with the selected item may be a part of the right click context menu 503 labeled by any appropriate label such as “Buy”, “Paypal® Buy”, or the like.

The “right click transaction option” may be developed and installed in client device 120, for example, as a browser plugin, which may be available for IE/Firefox browsers. After installing the plugins, the user may get the right click menu options including, for example, “Service Provider Buy” 505 appearing when the user right clicks on the image of selected item 501.

When the user right clicks on content (e.g., image or text) associated with an item such as on content resulting from a search on a search engine website page, for example, on any thumbnail image presented on a search engine site images results page as illustrated in FIG. 4, or on text or an image of item 501 as illustrated in FIG. 5, search information may be passed and/or stored at a server at a remote location such as service provider server 180. Search information may include, for example, a parameter, text associated with the item name, descriptive text, a name, a word(s) or a search string(s) for the item, e.g., “digital camera”.

In an embodiment, the search information may be passed to a service provider such as Paypal®.

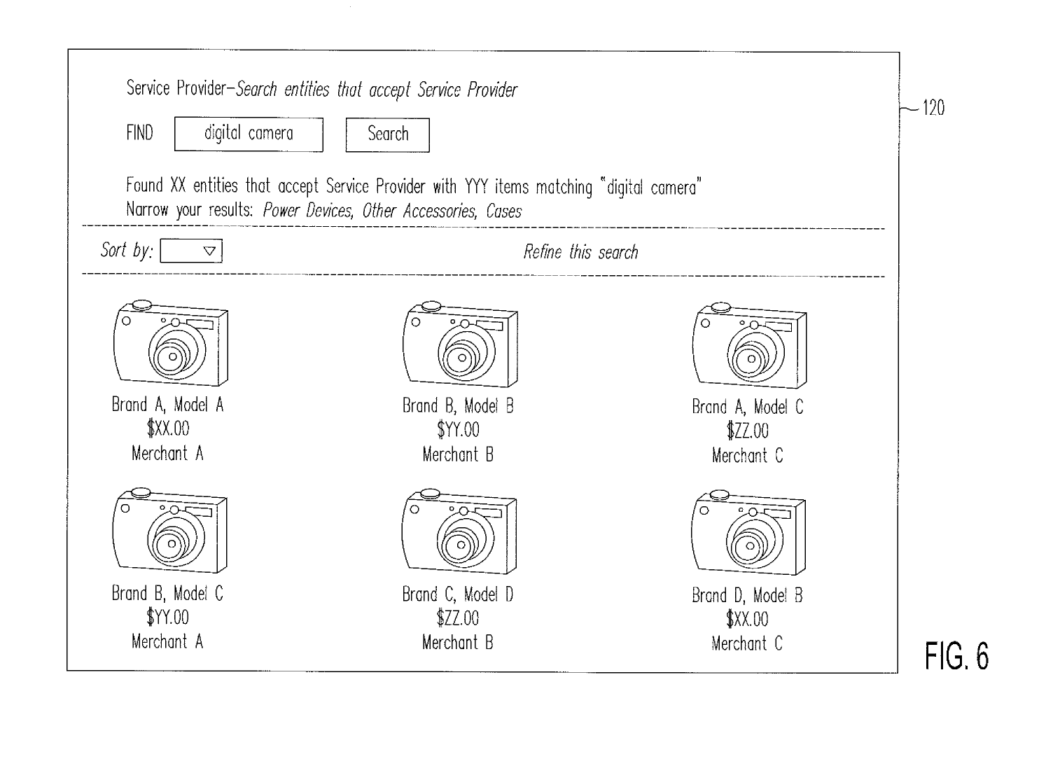

FIG. 6 illustrates a screen shot of a client device 120 illustrating a find page showing various items 602-1 to 602-M from service provider supported business entities.

In this example, the search information (including, for example, a parameter associated with a selected item such as a digital camera) may be passed to a service provider such as Paypal®. In general, the find page of the service provider site may be located at, for example, an address as follows:

http://paypal.thefind.com/search?query=<string><http://paypal.thefind.com/search?query=%3cstring%3e>

The embodiment of FIG. 6 illustrates a find page as the text filed against a search button as shown, for example, at a webpage having an address as follows:

http://paypal.thefind.com/search?query=digital camera

In other words, the search information may be passed through basic URL query function according to an embodiment, for example:

http://paypal. thefind.com/search?query=digita1 camera, which in this example may correspond to a similar page as illustrated in the embodiment of FIG. 6.

In other embodiments where a user selects text associated with an item on a webpage, and does a right click on the text and selects a similarly presented option for a right click transaction by selecting an appropriately labeled option such as “Buy”, “Service Provider Buy”, etc., the selected text may be similarly passed as search information to a site, for example, to a service provider such as Paypal® as described above.

It should be noted that the user may have the option to select an item from any of the merchants as illustrated in the embodiment of FIG. 6 to conduct a transaction in connection with the selected item such as to view, monitor, bid or purchase the item. For example, the user may be interested in conducting a transaction in connection with a digital camera of Brand A, Model A from Merchant A at the listed price of $XX.00. In an embodiment, the transaction (e.g. purchase) may be completed through the service provider.

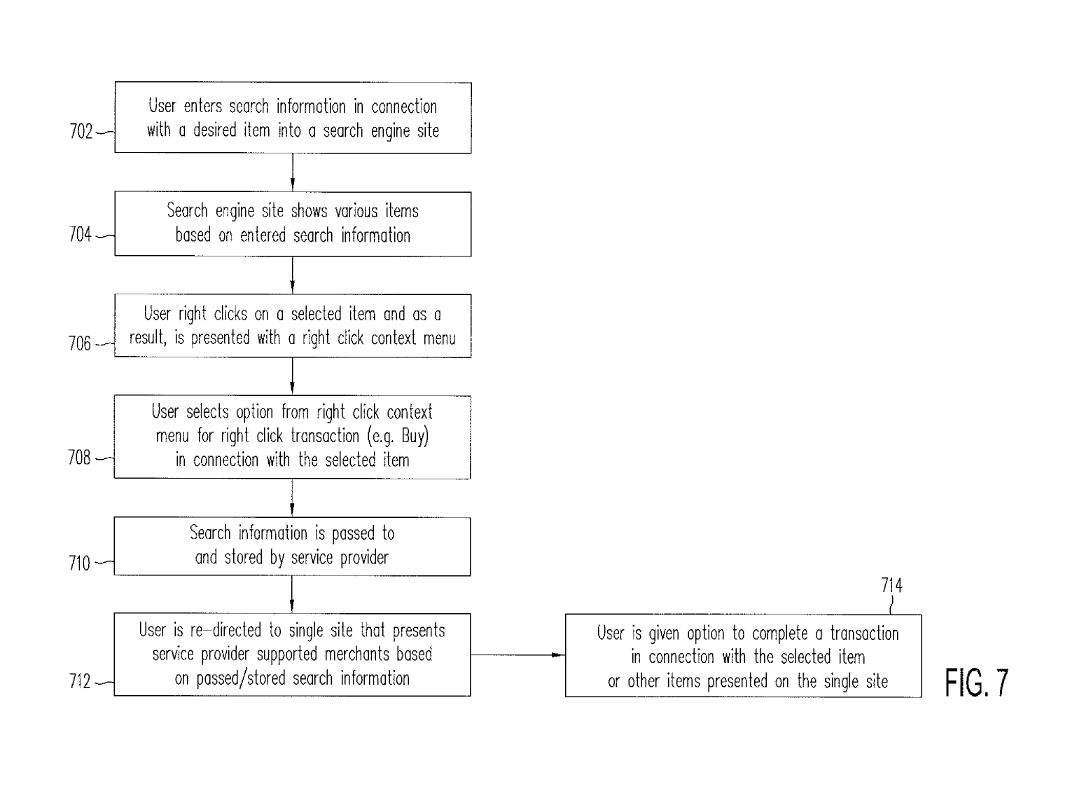

FIG. 7 is a method for an e-commerce experience for right click electronic commerce transactions over a client device according to an embodiment of the present disclosure.

In block 702, a user enters search information such as search terms, names, words, parameters, text or a search string into a search engine site, for example, an images search site. Search information may include specific characteristics for an item such as brand, model, size, color, etc.

In block 704, the search engine site shows results based on entered search information. For example, content such as images in the form of several thumbnails may be provided to the user that meet the searched for characteristics.

In block 706, the user may right click on a selected item and be presented with a right click context menu. It should be noted in other embodiments, the user may right click on content associated with an item such as an image or text found in any website such as review sites, shopping sites, social networking sites, etc.

In block 708, the user may select an option from the right click context menu for a right click transaction (e.g. buy) associated with the selected item.

In this regard, in block 710, the search information is passed and stored to a server at a remote location.

The server, for example, a service provider server, stores search information such as a parameter associated with the selected item when the user right clicks on text or an image of the item. For example, the server may store the term “camera” when the user right clicks on an image of a particular camera. As such, the server associates corresponding names, terms, words or search strings with the image. In various embodiments, an “exact string” of what the user entered to search in a search engine site may be used. For example, if the user searches “camera” then the term or string “camera” may be stored and associated with the corresponding image. That is, the search information such as names, words, terms or strings associated with an image or text of an item may simply be the names, words, terms or strings the user entered for the search that resulted in the image or text of the item.

In various embodiments, the user may search using more specific search information such as more descriptive terms, words or strings. For example, the user may enter more specific search terms or parameters such as “Canon EOS Rebel™” into a search engine image search page.

According to one embodiment, the system may fetch a number of parameters, for example, two parameters:

Parameter 1: the image name such as “Canon EOS Rebel™”, and

Parameter 2: the string “camera”, which the user entered in the search engine image search.

That is, the complete search information may include a parameter: “Canon EOS Rebel™ camera”.

It should be noted that in other embodiments, users may use search information that includes search strings having vague terms, for example, “Sony® xyz camera”. In these embodiments, the results may include images for various models of the specific brand such as “SonyES™ camera”.

Or in further embodiments, the search results may include a generic term such as “ABC”, which is not related to the searched string. In other words, in some embodiments, for example, the user may search for “Sony XYZ” and may find an image of “Sony XYZ”; however, the image name may be “ABC.JPEG”. The parameters in these cases that are not related may be invalid and may not be used as parameters to be passed and stored at a server at a remote location.

In embodiments where search information includes different parameters, such as a default parameter, which may be entered by a user, plus a parameter from the name of an image, the parameters may be coupled in such a way so that the search information is a searched string that may be used as a default parameter combined with the image name string. Therefore, the user is very likely to see results, for example, of at least “camera” after right clicking on an image.

In an example, a user may search for an item such as “sports jerseys” in a search engine site. The user may then be shown a wide variety of results for sports jerseys including, for example: a. basketball jerseys, b. baseball jerseys, c. football jerseys, etc. Also, the user may be shown jerseys with specific player names, such as a Kobe Bryant jersey, for example. The user may be interested in the particular player jersey and may perform a right click on an Image of a “Kobe Bryant jersey”, for example. In that case, two parameters may be passed to a server at a remote location: a. “Kobe Bryant jersey” and b. “Jersey”. In that regard, the image of a Kobe Bryant jersey may have descriptive text such as a descriptive image name string associated with the image. Most images in general may have a word description that may be extracted.

In another example, a user may enter a search term or word for an item such as a “Samsung® digital camera” or “Canon® digital camera” or “Nikon® XYZ-200”. Each of the resulting images may include descriptive text such as a descriptive image name associated with the particular image. As such, a parameter associated with a particular resulting image may be passed to the remote location server as the “image name”.

In an example where a user enters more generic terms, for example, where a user just enters “digital camera” or “jerseys” into a search box in a search engine images page (e.g., Google® images), the name of the resulting images may not be descriptive. As such, a search string, e.g., “digital camera” or “jersey”, may simply be passed as a default parameter. In this case, the search for “digital camera” or “jerseys” may produce several very specific cameras or jerseys. If the user right clicks on a specific type of camera or jersey, for example “Samsung wxy300”, the name of this resulting image is descriptive and may be passed as a parameter.

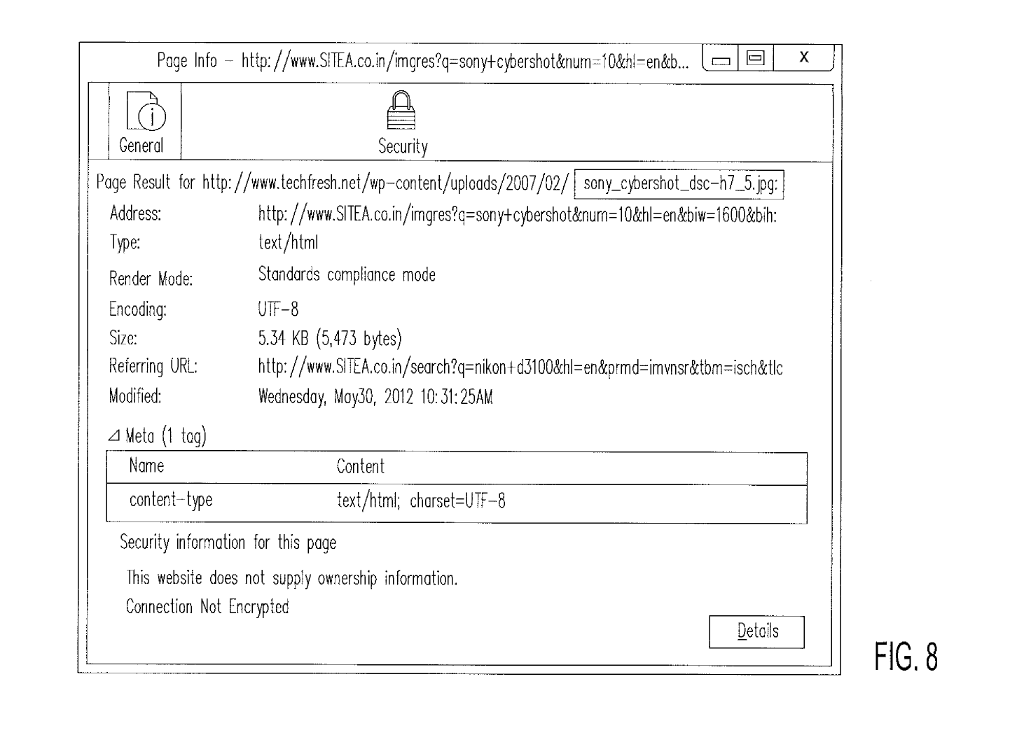

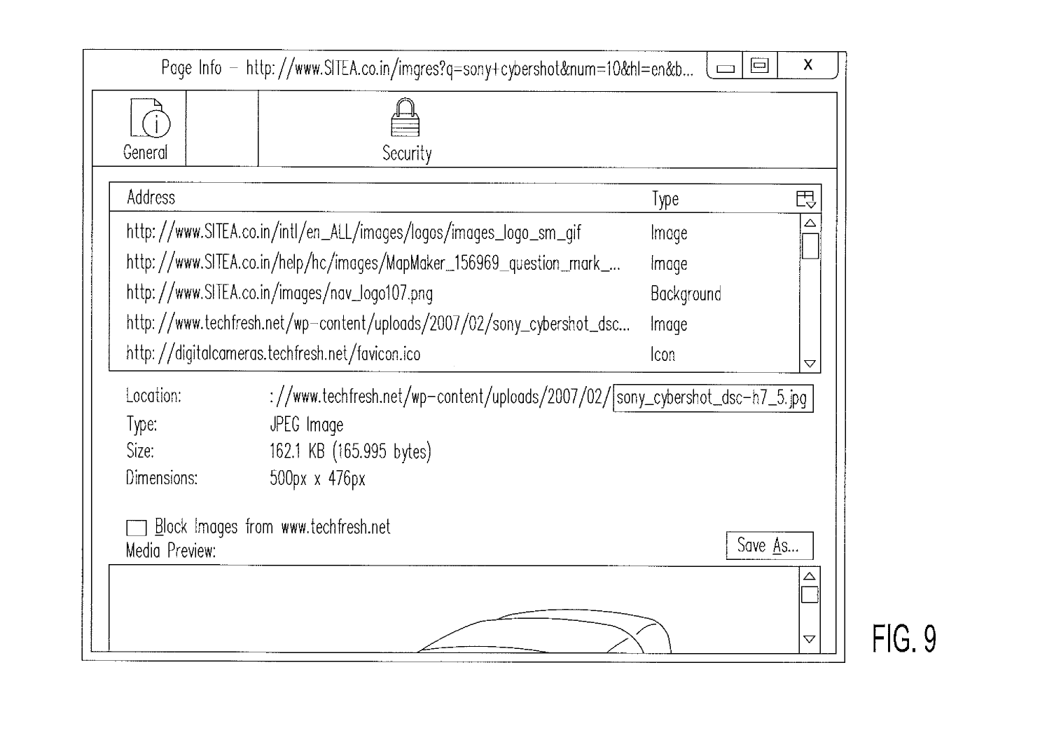

Referring back to FIG. 5, an image descriptive name and more details about an item may be obtained as illustrated in FIGS. 8-9 according to one or more embodiments.

In FIG. 5, an image descriptive name or desired details or more information about an image may be obtained, for example, by selecting “View Image Info” 507 or equivalent label, from menu 503. FIGS. 8 and 9 illustrate information pages about the particular image according to one or more embodiments. In this embodiment of FIGS. 8 and 9 more information may be obtained with respect to a “Sony Cybershot®” camera image from a referring URL of a Google® search results webpage, for example.

Referring back to FIG. 7, in block 712, the user may be redirected to a single site showing service provider supported merchants based on the passed/stored search information. For example, the user may be redirected to a site showing specific cameras searched along with corresponding merchants and potentially available best deals. Notably, even if search information such as a name is not descriptive, then the user may be redirected to a site with all “digital cameras” (based on default parameters) displayed from service provider (e.g., Paypal®) supported merchants.

In block 712, the user has the option to complete a transaction (e.g., view, shop, monitor, bid, purchase, etc.) in connection with the selected item or other items presented on the single site.

It should be noted that the examples described above such as examples for digital cameras or jerseys are only for illustration purposes and not to limit the scope of the present disclosure. As such, although embodiments of the present disclosure described herein may be directed to items in particular consumer contexts, it should be understood that embodiments of the present disclosure may also provide and be directed to a variety of items in any other contexts suitable for online shopping or electronic commerce.

It should be noted that although one or more embodiments of the present disclosure have been described with respect to “right-clicking” on an image or text associated with an item, embodiments herein may also include other features that allow users to search for items or for transaction options, such as by dragging and dropping an image into a search-bar or a tool bar, uploading an image, or selecting a URL.

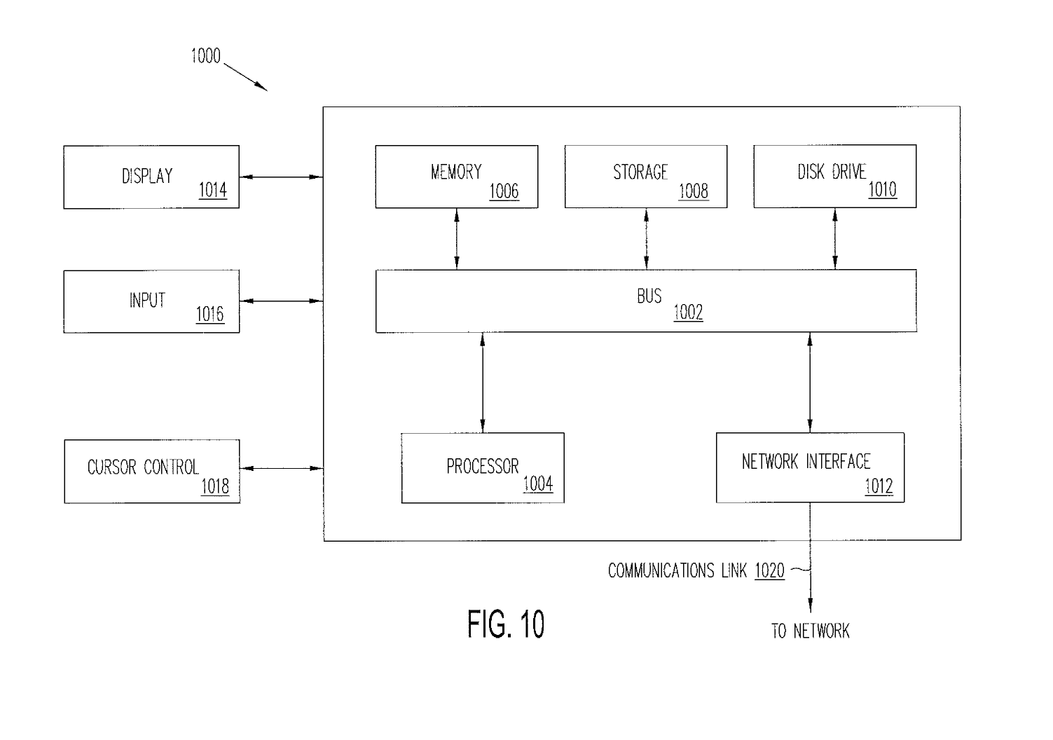

FIG. 10 is a block diagram of a system 1000 suitable for implementing embodiments of the present disclosure, including client device 120, one or more merchant servers or devices 140 and service provider server or device 180. System 1000, such as part of a smart phone, a tablet, a personal computer and/or a network server, includes a bus 1002 or other communication mechanism for communicating information, which interconnects subsystems and components, such as a processing component 1004 (e.g., processor, micro-controller, digital signal processor (DSP), etc.), a system memory component 1006 (e.g., RAM), a static storage component 1008 (e.g., ROM), a network interface component 1012, a display component 1014, an input component 1016 (e.g., keypad, touchpad, or keyboard), and a cursor control component 1018 (e.g., a mouse pad).

In accordance with embodiments of the present disclosure, system 1000 performs specific operations by processor 1004 executing one or more sequences of one or more instructions contained in system memory component 1006. Such instructions may be read into system memory component 1006 from another computer readable medium, such as static storage component 1008. These may include instructions to create, display, manipulate and/or share collections of e-commerce items. In other embodiments, hard-wired circuitry may be used in place of or in combination with software instructions to implement the embodiments of the present disclosure.

Logic may be encoded in a computer readable medium, which may refer to any medium that participates in providing instructions to processor 1004 for execution. Such a medium may take many forms, including but not limited to, non-volatile media, volatile media, and transmission media. In various implementations, volatile media includes dynamic memory, such as system memory component 1006, and transmission media includes coaxial cables, copper wire, and fiber optics, including wires that comprise bus 1002. Memory may be used to store search information associated with different e-commerce items. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the present disclosure, execution of instruction sequences to practice the embodiments of the disclosure may be performed by system 1000. In various other embodiments, a plurality of systems 1000 coupled by communication link 1020 (e.g., network 160 of FIG. 1, LAN, WLAN, PTSN, or various other wired or wireless networks) may perform instruction sequences to practice the embodiments of the present disclosure in coordination with one another. System 1000 may transmit and receive messages, data, information and instructions, including one or more programs (i.e., application code) through communication link 1020 and communication interface 1012. Received program code may be executed by processor 1004 as received and/or stored in disk drive component 1010 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure and is limited only by the claims.

What is claimed is:

1. A system comprising:
one or more processors; and
one or more memories in communication with the one or more processors and adapted to store a plurality of machine-readable instructions which when executed by the one or more processors are adapted to cause the system to:
provide a right click transaction option as part of a right click context menu when a user of a client device right clicks on content associated with a selected item as presented on an entity's site;
receive search information associated with the selected item from the user device when the user selects the right click transaction option;
store the search information; and
redirect the user to a service provider site of a server provider showing one or more items displayed from service provider supported business entities based on the received and stored search information.

2. The system of claim 1 wherein the plurality of instructions are adapted to further cause the system to give the user an option to select one or more desired items from the service provider site for viewing, monitoring, bidding, shopping or purchasing.

3. The system of claim 1 wherein the plurality of instructions are adapted to further cause the system to complete a transaction via the service provider.

4. The system of claim 1 wherein the plurality of instructions are adapted to further cause the system to receive a default parameter and/or descriptive text passed when the user selects the right click transaction option.

5. The system of claim 1 wherein the search information further comprises a name, a parameter, text, a word or a search string associated with the content.

6. The system of claim 1, wherein the content associated with the selected item further comprises text or a visual representation of the selected item.

7. The system of claim 1, wherein the entity's site further comprises an image search engine site.

8. The system of claim 1 wherein the service provider site further displays the one or more items along with top matching deals.

9. The system of claim 1, wherein the service provider further comprises a payment service provider server.

10. A method comprising:
providing, electronically by a processor, a right click transaction option as part of a right click context menu when a user of a client device right clicks on content associated with a selected item as presented on an entity's site;
receiving, electronically by the processor, search information associated with the selected item from the user device when the user selects the right click transaction option;
storing the search information; and
redirecting, electronically by the processor, the user to a service provider site of a server provider showing one or more items displayed from service provider supported business entities based on the received and stored search information.

11. The method of claim 10 further comprising giving the user an option to select one or more desired items from the service provider site for viewing, monitoring, bidding, shopping or purchasing.

12. The method of claim 10 further comprising giving the user an option to complete a transaction via the service provider.

13. The method of claim 10 further comprising receiving a default parameter and/or descriptive text passed when the user selects the right click transaction option.

14. The method of claim 10 wherein the search information further comprises a name, a parameter, text, a word or a search string associated with the content.

15. The method of claim 10, wherein the content associated with the selected item further comprises text or a visual representation of the selected item.

16. The method of claim 10, wherein the entity's site further comprises an image search engine site.

17. The method of claim 10 further comprising displaying, on the service provider site, the one or more items along with top matching deals.

18. A non-transitory computer readable medium on which are stored computer readable instructions and, when executed by a processor, cause the processor to:
provide a right click transaction option as part of a right click context menu when a user of a client device right clicks on content associated with a selected item as presented on an entity's site;
receive search information associated with the selected item from the user device when the user selects the right click transaction option;
store the search information; and
redirect the user to a service provider site of a server provider showing one or more items displayed from service provider supported business entities based on the received and stored search information.

19. The medium of claim 18 wherein the instructions further cause the processor to complete a transaction via the service provider.

20. The medium of claim 18 wherein the instructions further cause the processor to receive at least one default parameter and/or a descriptive image string passed when the user selects the right click transaction option.
